(19) United States
(12) Patent Application Publication
(10) Pub. No.: US 2010/0111487 A1
(43) Pub. Date: May 6, 2010

(54) Phosphate Glasses Suitable for Neutron Detection and Fibers Utilizing Such Glasses

(76) Inventors: Bruce Gardiner Aitken, Corning, NY (US); Sasha Marjanovic, Painted Post, NY (US)

Correspondence Address: CORNING INCORPORATED, SP-TI-3-1, CORNING, NY, 14831, US

(21) Appl. No.: 12/560,582

(22) Filed: Sep. 16, 2009

Related U.S. Application Data
(60) Provisional application No. 61/197,853, filed on Oct. 31, 2008.

(51) Int. Cl. G02B 6/00; C03C 3/19

(52) U.S. Cl. 385/141; 501/47

(57) ABSTRACT

A phosphate glass comprising: (i) 45 to 75 mole % P₂O₅; (ii) 0.5 to 30 mole % of at least one material selected from the group consisting of: Li₂O, B₂O₃, CdO, Gd₂O₃; (iii) 1 to 25 mole % Al₂O₃; (iv) 0.25 to 15 mole % Ce₂O₃; and (v) at least 0.25 mole % SnO and/or Sb₂O₃.

This application claims the benefit of, and priority to U.S. Provisional Patent Application 61/197,853 filed on Oct. 31, 2008 entitled, “Phosphate Glasses Suitable for Neutron Detection and Fibers Utilizing Such Glasses”, the content of which is relied upon and incorporated herein by reference in its entirety.

### BACKGROUND OF THE INVENTION

1. Field of the Invention

The present invention relates generally to cerium aluminophosphate glasses that include tin and/or antimony, for example lithium-cerium aluminophosphate glasses; and to fibers utilizing such glasses, and more particularly to glasses and fibers suitable for neutron detection.

2. Technical Background

Traditional neutron detectors are typically ³He or BF₃ gas-filled counter tubes and scintillating materials such as plastics, organics, semiconductors, or doped glass.

Neutrons are usually “invisible” to standard detectors. When neutrons undergo an interaction with the nucleus of an absorber material, e.g., ⁶Li, the energy and momentum of the neutron is drastically changed. If the neutron is captured, the capture reaction gives rise to secondary radiation and charged particles. These reaction products can be detected by conventional Coulombic interactions within a detector through excitation or ionization.

Neutron-sensitive scintillating glasses and fibers are an excellent alternative to traditional gas-filled detectors, since they are all solid state and they offer much better use of weight allowances. In addition, signal brightness due to the fluorescence of scintillating glasses can be used to separate the signal of neutrons from that of gamma rays, thereby preventing the detection of gamma ray radiation from innocent sources, such as medical equipment that uses isotopes, tiles made from quarry stone, or even foods, etc. Scintillating fibers also offer remote monitoring and video integration capability over networks, plus rugged designs for harsh vibration environments and temperatures, and would significantly reduce the cost of existing radiation portal monitors. For all of these reasons, efficient neutron sensors made from scintillating glasses and/or fibers have attracted special attention for homeland security, nuclear power generation and military applications.

However, current scintillating glass and fiber technology is focused on cerium-activated lithium aluminosilicate glasses and there are significant challenges associated with the use of these glasses and fibers made of these glasses. The amount of lithium oxide that can be practically incorporated in aluminosilicate glasses is limited to less than about 3 wt %, because cerium-activated lithium aluminosilicate glasses are prone to phase separation and/or devitrification at higher lithium concentrations. Accordingly, fibers made from such glasses must be fabricated by a rapid quenching double-crucible draw method, which is relatively expensive and not suitable for large commercial production. Oxidation state control in scintillating cerium-activated lithium aluminosilicate glasses must be strict in order to maximize the concentration of Ce³⁺ and, therefore, to avoid the formation of Ce⁴⁺. The presence of cerium in the latter state results in self-absorption, i.e. the absorption by Ce⁴⁺ of the fluorescence that arises from the interaction of neutrons with Ce³⁺, so that neutron detection is not possible. This requirement for oxidation control further increases glass cost. Moreover, useful fiber lengths are typically limited due to large attenuation losses arising from the presence of Ce⁴⁺. Altogether, these problems limit the overall neutron detection efficiency of cerium-activated lithium aluminosilicate scintillating glasses and fibers.

Cerium-lithium aluminophosphate glasses are known and have been used in applications other than scintillating glasses for neutron detectors. In these cerium-lithium aluminophosphate glasses Ce is largely present in the form of Ce⁴⁺, which causes self-absorption, making them unsuitable for use in neutron detectors.

### SUMMARY OF THE INVENTION

According to one aspect of the invention, an aluminophosphate glass comprises: (i) 45 to 75 mole % of P₂O₅; (ii) at least one material selected from the group consisting of: Li₂O, B₂O₃, CdO, Gd₂O₃; (iii) 1 to 25 mole % of Al₂O₃; (iv) 0.25 to 15 mole % Ce₂O₃; and (iv) at least 0.25 mole % of SnO and/or Sb₂O₃. According to some embodiments, the glass comprises 0.5 to 25 mole % Li₂O. Preferably, the amount of Li₂O is at least 3 mole %, more preferably at least 5 mole %, and even more preferably at least 10 mole %. According to embodiments of the present invention, the glass includes Ce ions in the 3+ state. Preferably, more than 90% of Ce ions are in the 3+ state.

The tin and/or antimony doped cerium-lithium aluminophosphate glasses of this invention are ideally suited for scintillating glass and fiber applications. These glasses are capable of having lithium and cerium contents that are substantially higher than those that of aluminosilicate glasses, which significantly improves neutron detection. The tin and/or antimony doped cerium-lithium aluminophosphate glasses are not prone to phase separation and/or devitrification problems as are lithium aluminosilicates. In these tin and/or antimony doped cerium-lithium aluminophosphate glasses Sn and/or Sb beneficially act as reducing agents that offer excellent oxidation state control. In addition, cerium absorption in these glasses is shifted to shorter wavelengths relative to that in aluminosilicate glasses, thereby offering better optical transmittance in visible range.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a cross-sectional view of one embodiment of the fiber according to the present invention.

FIG. 2 illustrates cerium fluorescence in lithium aluminophosphate and lithium aluminosilicate glasses.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

A glass suitable for neutron detection should include a neutron absorbing material and a scintillator. A neutron absorbing material combined with a scintillator is capable of interacting with incident neutrons to produce photons. According to some embodiments of the invention, an aluminophosphate glass 10 comprises: (i) 45 to 75 mole % of P₂O₅; (ii) at least one neutron absorbing material selected from the group consisting of: Li₂O, B₂O₃, CdO, Gd₂O₃; (iii) 1 to 25 mole % of Al₂O₃; (iv) 0.25 to 15 mole % Ce₂O₃; and (iv) at least 0.25 mole % of SnO and/or Sb₂O₃. According to some embodiments the glass 10 contains no more than 70 mole % P₂O₅. According to some embodiments the glass 10 contains 50 to 68 mole % P₂O₅. According to some embodiments the glass 10 contains 52 to 65 mole % P₂O₅.

The preferred neutron absorbing isotopes are ⁶Li and/or ¹⁰B. Because ⁶Li ions have a very high cross-section for thermal neutron capture and release a large amount of kinetic energy (4.79 MeV), ⁶Li is the preferred neutron absorbing material. As the natural abundance of ⁶Li in Li₂O is about 7.5%, higher concentrations of Li₂O will provide higher amounts of ⁶Li. According to some embodiments, the glass comprises 0.5 to 30 mole % Li₂O. For example, the amount of Li₂O in the glass may be 3, 3.5, 4, 5, 10, 12, 14, 15, 16, 18, 20, 22 or 25 mole %. According to some embodiments, the glass comprises 0.5 to 25 mole % Li₂O. It is noted that the glass 10 may be further enriched with ⁶Li ions.

Preferably, the amount of Li₂O is at least 10 mole %. Preferably the glass has at least 0.5 mole %, and more preferably at least 1 mole % of Ce₂O₃. The scintillation property of the glass 10 is due to the presence of Ce. The high lithium (Li) and cerium (Ce) contents in the glass advantageously provide significantly improved cross-section and scintillation, and thus increased neutron detection efficiency.

All glasses of the exemplary embodiments of the invention have been batched using commercially available raw materials. Lithium and aluminum were incorporated as lithium phosphate and aluminum metaphosphate, respectively. In some glass compositions, lithium and aluminum were batched as lithium carbonate and alumina, respectively. Phosphorus was added either as the metal phosphates or as ammonium phosphate. In a few exemplary glass compositions in which the amount of phosphorus contributed by the lithium and aluminum phosphate materials was less than the desired total concentration, the difference was batched as phosphorus pentoxide. Tin and antimony were batched as SnO and Sb₂O₃, respectively. Alternatively, tin and antimony can be batched in a different manner, for example, tin can be batched as Sn oxalate. Cerium was typically added as cerium oxalate, in which Ce is nominally present in the 3+ oxidation state. However, similar results in terms of glass coloration and, hence, Ce oxidation state were achieved when CeO₂ (in which Ce is nominally present in the 4+ oxidation state), was used instead—surprisingly, most of the cerium was reduced to the 330 oxidation state (during glass melting) due to the presence of Sn and/or Sb. The batches were mixed, charged into silica crucibles and melted at temperatures of 1200-1450° C. for 2-3 hours. The resultant melts were poured in cylindrical molds to form glass rods suitable for fiber draw.

Thus, according to embodiments of the present invention, glass 10 includes Ce ions that are in the 3+ state. Preferably, more than 90% of Ce ions are in the 3+ state, more preferably more than 98% or 99% of Ce ions are in the 3+ state. Preferably, the aluminophosphate glass 10 contains less than 1% of Ce ions in 4+ state, because of the undesirable self-absorption properties of these Ce⁴⁺ ions. It is SnO and/or Sb₂O₃ that act as reducing agents that provide excellent oxidation state control and minimize or eliminate the formation of Ce⁴⁺ ions and promote formation of Ce³⁺ ions. Advantageously, while glasses 10 are scintillating glasses, they are not prone to phase separation and/or crystallization problems typical of the lithium aluminosilicate glasses. It is noteworthy that aluminophosphate glasses 10 can provide very high doping of lithium and cerium but do not need to be made under reducing conditions.

Those skilled in art would understand that, in order to tailor certain glass properties such as thermal expansion or viscosity, lithium and cerium can be partially replaced by other oxides ROₓ, where R is selected from the group consisting of alkali metals (Na, K, Rb, Cs), alkaline earths (Be, Mg, Ca, Sr, Ba), zinc, boron, gallium, yttrium, lanthanum, and combinations thereof Thus, glass 10 may also include these materials. However, glass 10 should contain at least 0.5 mole % of Li₂O, at least 0.25 mole % Ce₂O₃, and at least 0.25 mole % of SnO and/or Sb₂O₃. Therefore, according to some embodiments, glass 10 contains 0 to 10 mole % of ROₓ, where R is: sodium, potassium, rubidium, cesium, beryllium, magnesium, calcium, strontium, barium, zinc, boron, gallium, yttrium, lanthanum and combinations thereof.

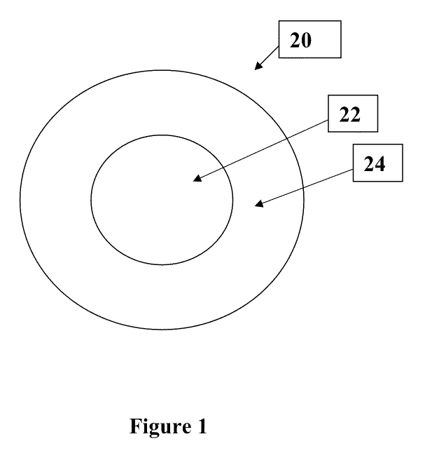

One embodiment of the fiber according to the present invention is shown in FIG. 1, and is designated generally throughout by the reference numeral 20. As embodied herein and depicted in FIG. 1, fiber 20 includes a fiber core 22, surrounded by the cladding 14. The fiber core 22 is made from glass 10 and comprises (i) 45 to 75 mole % of P₂O₅; (ii) 0.5 to 30 mole % of at least one material selected from the group consisting of: Li₂O, B₂O₃, CdO, Gd₂O₃; (iii) 1 to 25 mole % of Al₂O₃; (iv) 0.25 to 15 mole % Ce₂O₃; and (iv) at 0.25 mole % of SnO and/or Sb₂O₃. Core 22 is scintillating. The scintillation property of the core 22 is due to the presence of Ce³⁺ ions. Preferably, the neutron absorbing component is Li₂O, and the amount of Li₂O in the core 22 is least 10 mole %. According to embodiments of the present invention the core glass includes Ce ions in the 3+ state. According to the embodiments of the present invention, the glass core 22 has an outer diameter of 10 μm to 500 μm, and the cladding 24 has an outer diameter of 25 μm to 750 μm. According to some embodiments the core 22 has an outer diameter of 25 μm to 250 μm and the cladding 24 has an outer diameter of 50 μm to 300 μm. Preferably, the core 22 has an outer diameter of 100 μm to 200 μm to provide adequate cross-sectional area for neutron detection. Preferably, the cladding 24 is polymer and has an outer diameter of 125 μm to 300 μm. Preferably the cladding 24 is made of fluorinated coating material, such as fluorinated plastic.

The fiber core preforms of the fibers 20 can be made by a conventional redraw process (instead of a double-crucible draw process with rapid quenching), and then overclad with polymer (e.g., a polymer or acrylate) cladding. The plastic cladding 24 has a lower index of refraction than the glass core 22. The resulting fibers have good mechanical properties and good durability. The neutron capturing reaction by a ⁶Li ion produces an alpha particle and ³H. The alpha particle and ³H interact with the glass to produce a series of ionization processes by electronic excitations that excite Ce³⁺ ions. After the relaxation of excited Ce³30 ions to the ground state, optical photons are emitted. These represent cerium fluorescence. In other words, the alpha particle and ³H interaction with the glass results in the excitation of a cerium electron and the resulting de-excitation produces a photon with a wavelength around 400 nm Such scintillation further propagates through the glass core 22 of fiber 20, which acts as a wave guide, especially when clad with a lower refractive index coating. The fiber(s) 20 may be optically coupled to a photo-multiplier tube, where the photon is multiplied and converted to an electronic pulse that can be processed and counted.

The tin and/or antimony doped cerium-lithium aluminophosphate core(s) 22 of the fiber(s) 20 preferably have very high lithium and cerium contents for significantly improved cross-section for neutron detection. Both Sn and Sb act as reducing agents that offer excellent oxidation state control, therefore the +3 oxidation state of cerium is much easier maintained than in silica-based scintillating glasses. Moreover, the cerium absorption peak in glasses 10 is shifted to shorter wavelengths, thus offering better optical transmittance in visible range.

### Examples

The invention will be further clarified by the following glass examples. The amount of materials is provided in mole %. The inventive glasses D-J are colorless or only weakly tinted, which indicates the absence or very low amounts of Ce⁴⁺ ions.

| Oxide | Glass A | Glass B | Glass C | Glass D | Glass E | Glass F | Glass G | Glass H | Glass I | Glass J |
|---|---|---|---|---|---|---|---|---|---|---|
| P₂O₅ | 60.5 | 66.7 | 55.3 | 59.5 | 55.3 | 60.5 | 60.5 | 60.5 | 60.5 | 59.9 |
| Al₂O₃ | 18.4 | 15.4 | 24.1 | 18.4 | 18.4 | 13.2 | 15.3 | 17.4 | 15.8 | 15.1 |
| Li₂O | 15.8 | 15.4 | 20.1 | 15.8 | 15.8 | 15.8 | 15.8 | 15.8 | 15.8 | 15.6 |
| Ce₂O₃ | 5.26 | 2.56 | 0.5 | 5.26 | 5.26 | 5.26 | 5.26 | 5.26 | 5.26 | 5.21 |
| SnO | 0 | 0 | 0 | 1.05 | 5.26 | 5.26 | 3.16 | 0 | 0 | 3.12 |
| Sb₂O₃ | 0 | 0 | 0 | 0 | 0 | 0 | 0 | 1.05 | 2.63 | 1.04 |
| Glass | Yellow | Yellow | Yellow | Yellowish | Colorless | Colorless | Colorless | Pale yellow | Yellowish | Colorless |
| color | | | | | | | | | | |

More specifically, Table 1 lists the compositions and color of some manufactured glass embodiments. A yellow color indicates the presence of a significant concentration of Ce⁴⁺ ions, and such a glass can not be used for scintillating applications, unless it was melted in a strictly controlled environment under reducing conditions. A pale yellow tint qualitatively indicates a lesser number of Ce⁴⁺ ions, while a yellowish color reveals the least number of Ce⁴30 present in the glass. A colorless appearance indicates that virtually all cerium ions in the glass are in the 3+ oxidation state. The Table 1 data illustrate that both tin (Sn) and antimony (Sb) act as reducing agents in these glasses and that preferably that at least 1.5 mol % of SnO or at least 3 mol % of Sb₂O₃ is needed in cerium lithium aluminophosphate glasses to maintain sufficient Ce in the desired 3+ state for scintillating applications. These glasses 10 (glasses D-J) were drawn into glass fibers for splicing into typical glass optical fiber systems using standard techniques. Fibers 20 included glass core and polymer cladding. Their mechanical properties and chemical durability were excellent.

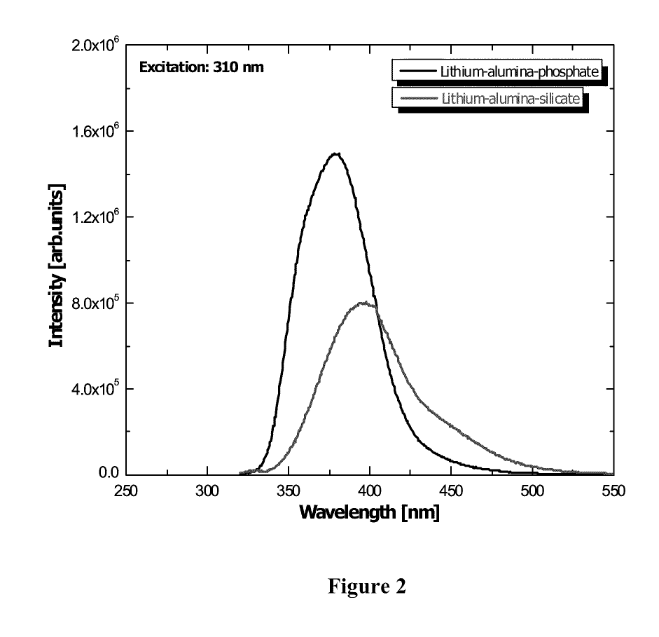

The optical glasses made according to the embodiments of the present invention provide better optical transmittance in the visible wavelength range as compared to the lithium aluminosilicate scintillating glasses commonly used for neutron detection, because the cerium absorption peak in phosphate glasses 10 is shifted toward shorter wavelengths relative to that in aluminosilicate glasses. In addition, a comparison of cerium fluorescence in lithium aluminophosphate and lithium aluminosilicate glasses for the excitation at 310 nm, shows stronger fluorescence of aluminophosphate glasses, as indicated in FIG. 2. The fact that the cerium fluorescence peak in a phosphate glass 10 is shifted toward shorter wavelengths implies a comparable shift in the cerium absorption peak towards shorter wavelengths (and thus less absorption in visible wavelengths), which therefore provides better optical transmittance in the visible range.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A phosphate glass comprising:
45 to 75 mole % P₂O₅;
0.5 to 30 mole % of at least one material selected from the group consisting of: Li₂O, B₂O₃, CdO, Gd₂O₃;
1 to 25 mole % Al₂O₃;
0.25 to 15 mole % Ce₂O₃; and,
at least 0.25 mole % SnO and/or Sb₂O₃.

2. The phosphate glass according to claim 1 comprising 3 to 30 mole % Li₂O.

3. The phosphate glass according to claim 2 wherein more than 90% of Ce ions are in the 3+ state.

4. The phosphate glass according to claim 1 wherein more than 90% of Ce ions are in the 3+ state.

5. The phosphate glass according to claim 3, said phosphate glass comprising:
50 to 70 mole % P₂O₅;
at least one isotope selected from the group consisting of: ⁶Li, ¹⁰B, ¹¹³Cd, ¹⁵⁷Gd;
5 to 20 mole % Al₂O₃;
2.5 to 10 mole % Ce₂O₃;
2 to 15 mole % SnO and/or Sb₂O₃.

6. The phosphate glass according to claim 5, said phosphate glass comprising at least: (i) 2.5 mole % SnO or Sb₂O₃; or (ii) at least 3 mole % of the combination of SnO and Sb₂O₃.

7. The phosphate glass according to claim 1 comprising no more than 70 mole % P₂O₅.

8. The phosphate glass according to claim 1 further comprising 0 to 10 mole % of ROₓ, where R is selected from the group consisting of sodium, potassium, rubidium, cesium, beryllium, magnesium, calcium, strontium, barium, zinc, boron, gallium, yttrium, lanthanum and combinations thereof.

9. An optical fiber comprising (i) a glass core made of phosphate glass according to claim 1, said core having diameter of 10 μm to 500 μm, and (ii) cladding having an outer diameter of 25 μm to 750 μm.

10. The optical fiber according to claim 9, said core having an outer diameter of 25 μm to 250 μm.

11. The optical fiber according to claim 9, said cladding having an outer diameter of 50 μm to 300 μm.

12. The phosphate glass according to claim 11 wherein more than 99% of Ce ions are in the 3+ state.

13. The phosphate glass according to claim 1 comprising no more than 25 mole % Li₂O.

14. The phosphate glass according to claim 1 comprising 5 to 30 mole % Li₂O.

15. The phosphate glass according to claim 1 wherein more than 95% of Ce ions are in the 3+ state.

16. The phosphate glass according to claim 1 wherein more than 98% of Ce ions are in the 3+ state.

17. The phosphate glass according to claim 11 wherein more than 99% of Ce ions are in the 3+ state.
